(19) United States
(12) Patent Application Publication
(10) Pub. No.: US 2009/0126478 A1
(43) Pub. Date: May 21, 2009

(54) Oval Gear Meter

(76) Inventors: Teuvo Moilanen, Saynatsalo (FI); Rauno Vehmaa, Muurame (FI)

Correspondence Address: Mark Ussai;SKF Usa Inc, 1111 Adams Avenue, Norristown, PA, 19403, US

(21) Appl. No.: 12/227,153

(22) PCT Filed: May 9, 2007
(86) PCT No.: PCT/FI2007/050262

§ 371 Date: Nov. 7, 2008

(30) Foreign Application Priority Data
May 12, 2006 (FI) 20065318

(51) Int. Cl. G01F 3/10

(52) U.S. Cl. 73/261

(57) ABSTRACT

The invention relates to an oval gear meter for flow measurement, the meter comprising: two oval-shaped gears (1, 2) arranged to rotate in synchronism in a chamber provided in a housing (3), through which chamber a medium to be measured is arranged to flow, the rotating motion of the gears (1, 2) being pro-portional to the flow rate. The meter is equipped with means for detecting the rotating motion of the oval gears (1, 2). The means for detecting the rotating motion of the oval gears (1, 2) comprise a permanent magnet (8) arranged to one of the oval gears (1 or 2), centrically with the rotating shaft (7) thereof, and a sensor circuit (9) arranged on the outer surface of the housing (3) wall, at a location coinciding with that of the permanent magnet (8).

The invention relates to an oval gear meter for flow measurement, the meter comprising: two oval-shaped gears arranged to rotate in synchronism in a chamber provided in a housing, through which chamber a medium to be measured is arranged to flow, the rotating motion of the gears being proportional to the flow rate and the meter being equipped with means for detecting the rotating motion of the oval gears.

Oval gear wheels of the above type are currently well known in connection with the flow measurement of a medium, such as a liquid, carried out in different fields of technology, for example.

An essential aspect relating to the use of oval gear meters is the detection of the rotating motion of the gears. The data obtained from the rotating motion of the gears enables the flow rate to be determined. In prior art solutions the rotating motion of the gears is often detected by providing the gear with a detection piece or a plural number of detection pieces. When a gear and a sensor housing structure made of an electrically non-conductive material is used, a detection piece made of metal may be detected using an inductive sensor. In case an electrically conductive, non-magnetizing gear and housing are used, the detection piece may be a magnet that is detected by means of a Reed- or Hall-type sensor placed outside the housing.

An advantage of the above solution principles is that the sensor may be placed outside a meter part enclosed in a housing. A disadvantage, in turn, is that they enable only a few pulses per gear revolutions, for example 1 to 4 pulses per gear revolution, to be obtained and therefore the information about the flow rate remains inadequate.

To eliminate problems relating to the inaccuracy of the above solutions, solutions in which an angle sensor is mounted to the oval gear shaft have been presented in the field. An advantage of such solutions is the number of pulses obtained, which may be 1000 pulses per revolution, for example, depending on the sensor type.

However, a problem with solutions employing an angle sensor arises from how to seal the rotating shaft to the housing of the measurement part.

Examples of cited prior art solutions include those described in Japanese publications 7190828, 8285654, 5264315 and in U.S. publication Pat. No. 5,992,230.

It is an object of the invention to provide a solution that allows the disadvantages of the prior art to be eliminated. This is achieved by an oval gear meter of the invention. The oval gear meter of the invention is characterized in that the means for detecting the rotating motion of the oval gears comprise a permanent magnet arranged to one of the oval gears, centrically with the rotating shaft thereof, and a sensor circuit arranged on the outer surface of the wall of the housing at a location coinciding with that of the permanent magnet.

An advantage of the invention is, above all, that it allows a precise measurement to be provided, without any problems associated with sealing. In other words, the invention succeeds in combining the advantages of the prior art solutions and eliminating their disadvantages.

In the following the invention will be disclosed with reference to an example of an embodiment illustrated in the accompanying drawings, in which

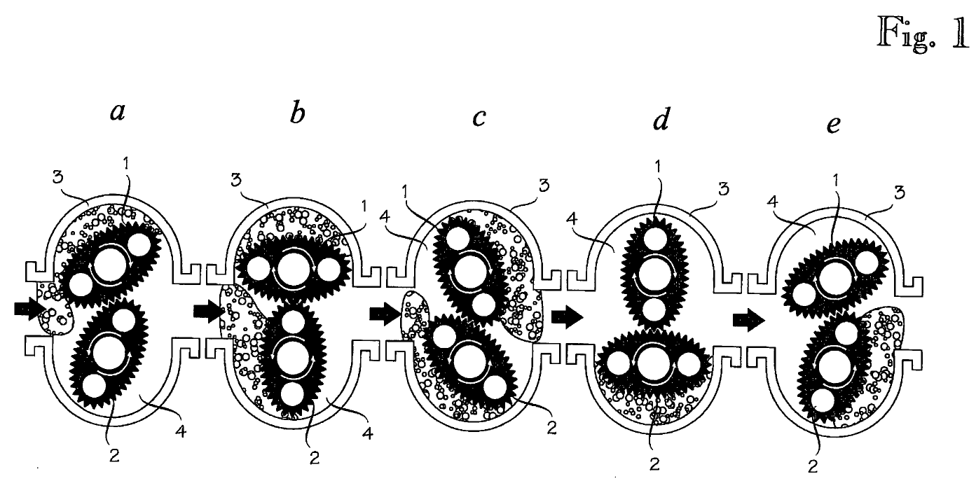

FIGS. 1a to 1e provide a series of schematic views of the operating principle of an oval gear meter;

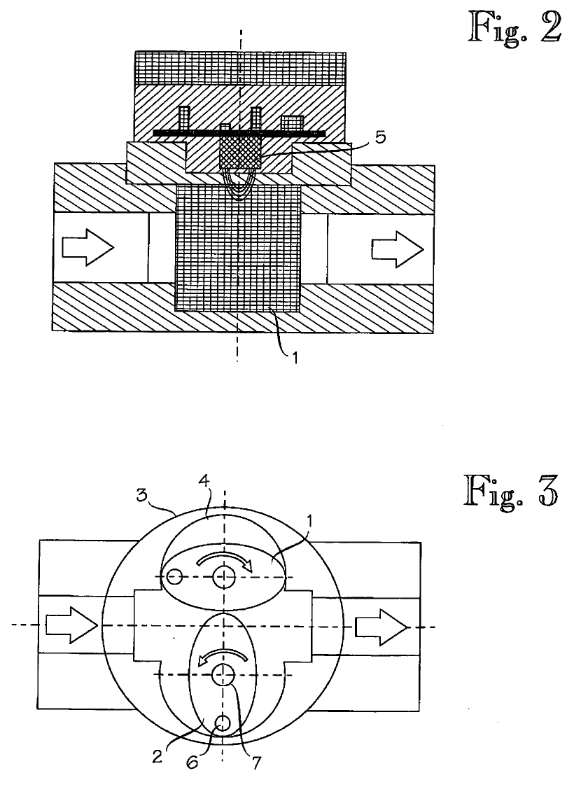

FIG. 2 illustrates an example of a prior art solution for the detection of gear movement;

FIG. 3 is a view illustrating the example of FIG. 2 from another direction;

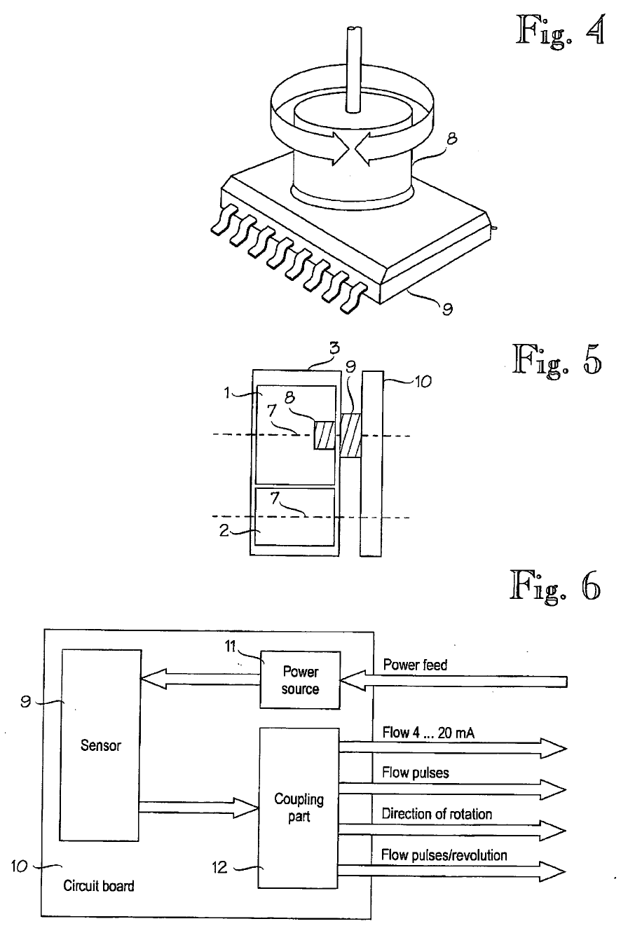

FIG. 4 illustrates the basic principle of a sensor used in the solution of the invention;

FIG. 5 is a schematic view of the detection of an oval gear in a meter of the invention; and

FIG. 6 is a block diagram of a sensor function and different coupling alternatives of the solution of the invention.

FIGS. 1a to 1e provide a series of schematic views of the operating principle of an oval gear meter. The oval gears are indicated with reference numerals 1 and 2. The gears 1, 2 are arranged to rotate in synchronism inside a chamber 4 formed in a housing 3, a medium to be measured being arranged to flow through the chamber. The rotating motion of the gears 1, 2 is proportional to the flow rate.

Since the technology relating to the operating principle of an oval gear meter is generally known among skilled persons, aspects related to it are not discussed in greater detail in this context.

Further, an essential feature in the operation of the oval gear meter is the detection of the rotation of the gears. FIGS. 2 and 3 illustrate an example of a prior art gear motion detection principle.

Like reference numerals are used in FIGS. 2 and 3 for like parts shown in FIGS. 1a to 1e. The operation of the example shown in FIGS. 2 and 3 is based in the use of a Hall sensor. The Hall element is indicated in the figures by reference numeral 5 and a magnet arranged to the gear, in turn, by reference numeral 6. In addition, FIG. 3 clearly shows shafts 7 on which the oval gears are arranged to rotate.

A solution that operates on the basis of a Hall element also represents technology that is generally known to a skilled person and therefore aspects related to it are not disclosed in closer detail in this context. FIGS. 2 and 3 also show that a disadvantage of the solution is that the amount of pulses obtained per gear revolution is small and therefore the meter does not provide the best possible characteristics as regards precision.

A basic idea of the invention is to provide an oval gear meter solution that combines the advantages of the prior art, i.e. detection of gear motion from outside the housing and use of an angle-sensor-type measurement principle, whereby a large number of pulses per gear revolution are obtained and a high measurement resolution is achieved.

According to the invention, gear motion is detected by means of a magnetic angle sensor the basic principle of which is shown in FIG. 4. The construction consists of a permanent magnet 8 and a sensor circuit 9. The permanent magnet 8 is placed to one of the oval gears, centrically with the rotating shaft 7 thereof, and is arranged to rotate along with the gear. The sensor circuit 9 is placed on the outer surface of the wall of the housing 3, at a location coinciding with that of the permanent magnet 8. FIG. 5 is a schematic view of the construction of the invention. FIG. 5 also shows a circuit board, indicated by reference numeral 10, on which the sensor circuit 9 is arranged.

The thickness of the housing 3 wall between the sensor circuit 9 and the permanent magnet 8 may be 0.5-1.8 mm, for example. The housing may be made of any suitable material, such as non-magnetizing steel.

The sensor circuit 9 is arranged to produce one pulse per revolution for the angular position of the permanent magnet 8 preferably at intervals of less than one degree, for example 0.35 degrees. Any suitable sensor circuit may be used as the sensor circuit 9. Examples of suitable sensor circuits include Austria Microsystems AS5040, whose resolution is 10 bits, which means that 1024 pulses are obtained for each full turn of the permanent magnet 8, i.e. the pulse interval is 0.35 degrees. In addition to providing the pulses the sensor circuit 9 indicates the direction of rotation and the absolute position of the permanent magnet 8 in the form of both a digital and a PWM signal. Suitable sensor circuits are available from other circuit manufacturers, too.

FIG. 6 is a block diagram illustrating an example of the sensor functions and different coupling alternatives of the solution of the invention. Like reference numerals are used in FIG. 6 for like parts shown in the figures discussed above. In addition, reference numeral 11 indicates a power source and reference numeral 12 a coupling part.

The above example of an embodiment is in no way meant to restrict the invention, but the invention may be fully freely modified within the scope of the claims. Consequently, it is obvious that the oval gear meter of the invention or details thereof do no necessarily need to be exactly as shown in the figures, but other solutions are also possible. For example, FIG. 6 is not to be considered as any kind of restrictive solution, but only as an example of various other alternatives, etc.

1. An oval gear meter for flow measurement, the meter comprising:
two oval shaped gears arranged to rotate in synchronism in a chamber provided in a housing through which chamber a medium to be measured is arranged to flow, the rotating motion of the gears being proportional to a flow rate of the medium; and
means for detecting the rotating motion of the oval gears comprise including a permanent magnet arranged to one of the oval gears centrically with the rotating shaft thereof, and a sensor circuit arranged on the outer surface of the wall of the housing at a location coinciding with that of the permanent magnet.

2. The meter according to claim 1, wherein the sensor circuit is arranged to deliver a pulse for the angular position of the permanent magnet on each revolution at intervals of less than one degree.

3. The meter according to claim 2, wherein the sensor circuit is arranged to deliver a pulse for the angular position of the permanent magnet at intervals of 0.35 degrees.
